(19) United States
(12) Patent Application Publication
(10) Pub. No.: US 2004/0157759 A1
(43) Pub. Date: Aug. 12, 2004

(54) Stripper formulations and process

(75) Inventor: Gary A. Scherubel, St. Louis, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Buckeye International, Inc.

(21) Appl. No.: 10/361,047

(22) Filed: Feb. 7, 2003

(51) Int. Cl. C11D 1/00

(52) U.S. Cl. 510/201

(57) ABSTRACT

Improved stripper formulations for use on metal cross linked floor finishes comprise a compound selected from the group consisting of a chelant containing an amine functionality and a metal chelating ligand, an alkali metal salt of the chelant, an aliphatic or aromatic polyamine, the aromatic polyamine having the amine functionality outside the aromatic ring, and mixtures of the chelant and polyamine. The stripper formulations are applied to metal cross linked floor finishes in a process for stripping such finishes.

### BACKGROUND OF THE INVENTION

This invention relates to stripper formulations and, more particularly, to improved stripper formulations for use on metal cross linked floor finishes.

Stripper formulations currently in use on metal cross linked floor finishes typically are highly alkaline due to the presence of caustic and/or monoethanol amine (MEA) used to break the metal cross link bond. Once the metal cross link is disrupted, solvency can then dissolve the polymer contained in the finish and remove the finish from the floor.

There remains a need, therefore, for stripper formulations which are more neutral in nature which in turn requires finding another way to break the metal cross link bond more efficiently and without the use of highly alkaline solutions.

### SUMMARY OF THE INVENTION

Among the several objects of the invention may be noted the provision of improved stripper formulations for use on metal cross linked floor finishes; the provision of such improved stripper formulations which require a much smaller molar concentration of the active stripper component than normally used for monoethanol amine in currently available stripper formulations; and the provision of such stripper formulations and a process for applying such formulations to metal cross linked floor finishes to remove such finishes from the floor. Other objects and features will be in part apparent and ain part pointed out hereinafter.

Briefly, the present invention is directed to a process for stripping metal cross linked floor finishes which comprises applying thereto a stripper formulation containing a compound selected from the group consisting of a chelant containing an amine functionality and a metal chelating ligand, an alkali metal salt of said chelant, an aliphatic or aromatic polyamine, the aromatic polyamine having the amine functionality in a substitutent outside the aromatic ring, and mixtures of said chelant and polyamine. The invention is also directed to the aforementioned stripper formulations.

### DESCRIPTION OF THE PREFERRED EMBODIMENTS

In accordance with the present invention, it has now been found that through the use of certain polyamines and chelating agents, stripper formulations may be prepared which provide enhanced stripper performance over monoethanol amine and caustic found in many stripper formulations. As shown by the test data presented hereinafter, the stripper formulations of the present invention not only provide improved stripper performance but permit such improved results while employing a much lower concentration of active ingredient as compared with the normal monoethanol amine concentration found in may strippers.

The improved stripper performance results from using stripper formulations which contain a chelant containing an amine functionality and a metal chelating ligand, an alkali metal salt of such a chelant, an aliphatic or aromatic polyamine, the aromatic polyamine having the amine functionality in a substituent outside the aromatic ring, or mixtures of such a chelant and polyamine. While not being bound by any particular theory, it is believed that the amine functionality present in the above-mentioned chelant or polyamine functions to break the metal cross link in metal cross linked floor finishes. When a chelant is employed, the chelating ligand ties up the freed metal and allows the amine functionality to again break another metal cross link bond. With the metal cross link disrupted by either a chelant or polyamine as stated above, the polymer in the floor finish can then be dissolved and removed from the floor.

Among the chelants containing an amine functionality and a metal chelating ligand which may be used in the practice of the invention may be mentioned ethylenediamine tetraacetic acid, diethylenetriamine pentaacetic acid, triethylenetetramine hexaacetic acid, nitriloacetic acid, iminodisuccinic acid and alkali metal (e.g. sodium or potassium) salts thereof. Other useful chelants will be apparent to those skilled in the art. The use of such chelants in the process of the invention is so efficient that the chelant can be employed at a 30 to 50 times lower molar concentration than normally used for monoethanol amine. Thus, monoethanol amine is typically present in available stripper formulations at a concentration between 10% to 15% by weight or between 0.16 and 0.25 moles. On the other hand, using sodium iminodisuccinate in accordance with the present invention, 5% of a 34% active solution can be used to make an effective stripper formulation, a molar concentration of 0.00504 moles. Using a similar molar amount of monoethanol amine in a stripper formulation results in inferior performance. Thus, a stripper formulation containing 5% sodium iminodisuccinate removed all 7 lines or layers of finish after 99 strokes in a neutral stripper test whereas a formulation containing a similar molar amount of monoethanol amine removed only 2 lines or layers of finish after 200 strokes.

It has also been demonstrated that the use of a chelant having no amine grouping or functionality provides inferior results. Thus, a test comparing a stripper formulation containing Liquid Gluconate 60 (a blend of gluconic acid and sodium gluconate marketed by PMP Fermentation Products, Inc.) and a stripper formulation containing the tetrasodium salt of ethylenediamine tetraacetic acid showed that the latter is clearly superior.

Monofunctional amines, whether they be aromatic or aliphatic, do not function effectively in the practice of the present invention. For example, ethanolamine does not function well whereas ethylenediamine functions satisfactorily and performance is futher enhanced with the use of diethylenetriamine. Similarly, monofunctional aromatic amines such as aniline, 2-aminopyridine, 2-aminopyrimidine and 3-aminobenzoic acid, which have the amine functionality outside the aromtic ring, do not function well whereas 2-aminobenzylamine does. Accordingly, aromatic monoamines are excluded from use in the practice of the invention as are aromatic polyamines having the amine functionality or moiety within the aromatic ring.

It has also been found that certain compounds such as anthranillic acid which contain both an amine group and a chelant moiety do not function in the practice of the invention and provide inferior performance to other chelants containing an amine functionality. This is due to the fact that in anthranillic acid, the amino group can resonate with the aromatic ring and carboxylate group thereby greatly reducing the basicity or alkalinity of the nitrogen. Chelants of this type are excluded from the class of chelants intended for use in the practice of the present invention.

Among the aliphatic or aromatic polyamines which may be used in the present invention may be mentioned ethylene diamine, diethylene triamine, triethylenetetramine, tetraethylene pentamine, diethylenetriamine pentaacetic acid and triethylenetetramine hexaacetic acid. Other polyamines for use in the present invention will be apparent to those skilled in the art. If an aromatic polyamine is employed, it must have the amine functionality in a substituent outside the aromatic ring. Tests have demonstrated that such polyamines substantially improve stripper performance over monoethanol amine at very low concentrations. Thus, for example, a test comparing a stripper containing 0.00504 moles monoethanol amine with one containing 0.00504 moles ethylene diamine showed that the former was far inferior to the latter. The preferred polyamines are diethylene triamine and a mixture of diethylene triamine and diethylenetriamine pentaacetic acid.

In accordance with the invention, the use of the aforementioned chelants and polyamines provides enhanced stripper performance over monoethanol amine and caustic found in many stripper formulations. An increase in performance is observed not only in neutral stripper formulations but also in highly alkaline stripper formulations such as that marketed under the trade designation Revelation by Buckeye International, Inc., St. Louis, Mo. Moreover, not only is stripper performance enhanced through the practice of the invention, but such enhancement is achieved using a 50 fold decrease in concentration of the chelant or polyamine as compared with the normal monoethanol amine concentration found in many stripper formulations.

In general, a weight range of from approximately 0.1% to approximately 10% by weight of the chelant or polyamine can be used in the practice of the invention. For example, diethylenetriamine is used at 0.5% by weight for maximum performance and sodium iminodisuccinate (in a 34% active solution) is used at 5% by weight. In both of these instances, the molar amount of diethylenetriamine (MW=103) and sodium iminodisuccinate (MW=337) is nearly equal, being approximately 0.005 moles.

In the examples set forth hereinafter, a solvent is included to dissolve the polymer in the metal cross linked floor finish, a surfactant is included to lower surface tension and aid the solvent in dissolving the polymer, isononanoic acid is included as a coupling agent to help put the solvent into solution and zonyl NF is included as a fluorosurfactant which helps in lowering surface tension and suppressing foaming. As previously indicated, the chelant or polyamine functions to break the zinc or other metal cross-link bond and to dissolve the finish.

In the case of the use of a chelant containing an amine functionality in the practice of the invention, it is believed that the amine functionality breaks the metal cross link of metal cross linked floor finishes while the chelating ligand subsequently ties up the freed metal thereby allowing the amine group to break another metal cross link bond. This process is so efficient that the chelant can be used at a 30 to 50 times lower molar concentration than normally used for monoethanol amine. Typically, MEA is present at between 10% to 15% (0.16 to 0.25 moles) in stripper formulations. In accordance with the present invention, using sodium iminodisuccinate for example as the chelant with an amine functionality, 5% of a 34% active solution (0.00504 moles) can be used to make an effective stripper formulation.

As shown by the test data set forth hereinafter, the use of a chelant with no amine functionality produces stripper formulations which provide inferior results. This is demonstrated by comparing stripper formulations containing Luquid Gluconate 60 in formulation 9-131 with 9-129A and 9-130 which both contain the tetrasodium salt of ethylenediamine tetraacetic acid. Liquid Gluconate 60 is a blend of gluconic acid and sodium gluconate in an aqueous solution having a 60% equivalent of sodium gluconate when neutralized with caustic soda, and is marketed by PMP Fermentation Products, Inc.

The following examples illustrate the practice of the invention.

### EXAMPLE 1

The following procedures were used in evaluating the stripper formulations of the invention.

### Tile Preparation

A white 12″×12″ vinyl composition tile was coated with a layer of desired finish. In these procedures, the finish employed was that marketed under the trade designation Castleguard by Buckeye International, Inc. of St. Louis, Mo. When the finish had completely dried, a line was drawn across the tile using an M. Grumbacher 6B woodless pencil. This type of pencil is used to draw the line because the finish does not smear the pencil line and the pencil line does not repel the finish.

Another coat of finish was put down, allowed to dry and a second pencil line was drawn across the tile. This process was continued until 8 coats of finish and 7 pencil lines had been put down on the tile.

After the last coat of finish had completely dried, the tile was placed in a 77° C. oven for a period of time, generally 2 to 3 days, to simulate aging. The tiles were then removed from the oven and allowed to cool to room temperature.

### Stripper Test Procedures

The prepared tiles were then stripped with various stripper formulations diluted to the desired strength, while also running a control. The stripping was done using a Gardner Washability and Wear Tester using a pad wetted with a predetermined amount of stripper formulation solution.

The cumulative number of stokes to remove each successive pencil line represents the number of strokes required in turn to remove each successive layer of finish and thus provides a relative comparison of stripper formulation performance.

### EXAMPLE 2

The following stripper formulations were prepared:

| | % Components | | | | | | |
|---|---|---|---|---|---|---|---|
| Component | 9-171A | 9-172 | 9-173 | 9-174 | 9-175 | 9-169 | 9-170 |
| Soft Water | 65.6 | 65.5 | 65.4 | 65.5 | 65.4 | 65.05 | 64.4 |
| Sodium Borate | 2.0 | 2.0 | 2.0 | 2.0 | 2.0 | 2.0 | 2.0 |
| Dowanol DPnB | 15.0 | 15.0 | 15.0 | 15.0 | 15.0 | 15.0 | 15.0 |
| Dowanol PPh | 5.0 | 5.0 | 5.0 | 5.0 | 5.0 | 5.0 | 5.0 |
| Neodol 1-5 | 3.0 | 3.0 | 3.0 | 3.0 | 3.0 | 3.0 | 3.0 |
| Neodol 1-9 | 4.0 | 4.0 | 4.0 | 4.0 | 4.0 | 4.0 | 4.0 |
| DiethyleneTriamine | 0.1 | 0.2 | 0.3 | 0.4 | 0.5 | 0.9 | 1.8 |
| Isononanoic Acid | 4.0 | 4.0 | 4.0 | 4.0 | 4.0 | 4.0 | 4.0 |
| 50% NaOH | 1.0 | 1.0 | 1.0 | 0.8 | 0.8 | 0.75 | none |
| Zonyl NF | 0.3 | 0.3 | 0.3 | 0.3 | 0.3 | 0.3 | 0.3 |

The above stripper formulations were evaluated for stripper performance using the procedures of Example 1. The product denoted as Liq. Shovel is a stripper formulation marketed under the trade designation Liquid Shovel by Buckeye International, Inc. of St. Louis, Mo. When an entry such as “80% at 90 strokes” appears, it indicates the degree of removal of the pencil line at 90 strokes.

| 32 oz/gal | Strokes to Remove Pencil Line | | | | | | |
|---|---|---|---|---|---|---|---|
| Product | 7 | 6 | 5 | 4 | 3 | 2 | 1 |
| Liq. Shovel | 28 | 40 | 51 | 61 | (78) | 75 | 96 |
| 9-171A | 29 | 44 | 62 | 70 | (93) | 86 | 111 |
| 9-172 | 26 | 40 | 56 | 67 | 79 | 84 | 104 |
| 9-173 | 30 | 45 | 56 | 64 | 89 | 106 | 109 |
| 9-174 | 26 | 40 | 52 | 60 | 76 | 85 | 112 |
| Liq. Shovel | 19 | 29 | 42 | 48 | (66) | 64 | 96 |
| 9-175 | 22 | 33 | 43 | 53 | 62 | 67 | 88 |
| Liq. Shovel | 36 | 62 | 83 | 116 | 149 | 149 | 159 |
| 9-169 | 24 | 41 | 45 | 46 | 65 | 69 | 82 |
| 9-170 | 21 | 34 | 47 | 55 | 74 | 85 | 80% at 90 strokes |

### EXAMPLE 3

The following stripper formulations were prepared:

| | % Components | | | | | | | |
|---|---|---|---|---|---|---|---|---|
| Component | 9-130 | 9-129A | 10-1 | 10-2 | 10-4 | 10-5 | 9-155 | 10-7 |
| Soft Water | 58.99 | 62.05 | 62.7 | 64.7 | 61.95 | 65.4 | 61.67 | 64.7 |
| Na Borate | 2.0 | 2.0 | 2.0 | 2.0 | 2.0 | 2.0 | 2.0 | 2.0 |
| Dowanol DPnB | 15.0 | 15.0 | 15.0 | 15.0 | 15.0 | 15.0 | 15.0 | 15.0 |
| Dowanol PPh | 5.0 | 5.0 | 5.0 | 5.0 | 5.0 | 5.0 | 5.0 | 5.0 |
| Neodol 1-5 | 3.0 | 3.0 | 3.0 | 3.0 | 3.0 | 3.0 | 3.0 | 3.0 |
| Neodol 1-9 | 4.0 | 4.0 | 4.0 | 4.0 | 4.0 | 4.0 | 4.0 | 4.0 |
| Na₄EDTA Hampene 100S | 4.8 | 2.4 | 2.0 | 1.0 | | | | |
| Diethylenetriamine | | | | | | | | |
| Pentaacetic Acid | | | | | | | 2.0 | 0.5 |
| Na Iminodisuccinate | | | | | 3.0 | 1.0 | | |
| Isononanoic Acid | 5.25 | 5.0 | 5.0 | 4.0 | 4.5 | 3.5 | 4.0 | 4.0 |
| 50% NaOH | 1.66 | 1.25 | 1.0 | 1.0 | 1.25 | 0.8 | 3.03 | 1.5 |
| Zonyl NF | 0.3 | 0.3 | 0.3 | 0.3 | 0.3 | 0.3 | 0.3 | 0.3 |

In the above formulations, Dowanol DPnB is dipropylene glycol n-butyl either (solvent), Dowanol PPh is 1-phenoxy-2-propanol (solvent), Neodol 1-5 and Neodol 1-9 are linear primary alcohols, Hampene 100S is tetrasodium ethylenediamine tetraacetate, and Zonyl NF is a fluorosurfactant marketed by DuPont.

The above stripper formulations were evaluated for stripper performance using the procedures of Example 1. The product denoted as Liq. Shovel is a stripper formulation marketed under the trade designation Liquid Shovel by Buckeye International, Inc.

| 32 | Strokes to Remove Pencil Line | | | | | | |
|---|---|---|---|---|---|---|---|
| oz/gal Product | 7 | 6 | 5 | 4 | 3 | 2 | 1 |
| 9-130 | 18 | 30 | 38 | 46 | 56 | 67 | 99.9% at 75 strokes total |
| 9-129A | 16 | 28 | 36 | 46 | 48 | 54 | 72 at 75 strokes total |
| 10-1 | 18 | 31 | 42 | 55 | 59 | 66 | 89 at 100 strokes total |
| 10-2 | 41 | 71 | 95 | 110 | 143 | 172 | 72 at 175 strokes total |
| Liq. Shovel | 45 | 56 | 86 | 129 | 131 | 153 | 99% at 175 strokes total |
| 10-4 | 51 | 78 | 97 | 153 | 153 | 181 | 99% at 200 strokes total |
| 10-5 | 81 | 132 | 173 | 221 | 238 | 245 | 60% at 250 strokes total |
| 9-155 | 32 | 53 | 69 | 110 | (149) | 143 | 134 at 200 strokes total |
| 10-7 | 55 | 71 | 130 | 167 | 90% | 80% | 80% at 200 strokes |

The percentages given in the above tables indicate the degree of removal after the indicated number of strokes. The number of strokes set forth in the last column reflects the total number of strokes applied based upon 25 stroke increments.

### EXAMPLE 4

The following stripper formulations were prepared:

| | % Components | | | | | | | | |
|---|---|---|---|---|---|---|---|---|---|
| Component | 9-180 | 9-181 | 9-187 | 9-185 | 9-19 | 9-182 | 9-184 | 9-186 | 9-183 |
| Soft Water | 65.298 | 65.222 | 65.296 | 65.217 | 65.227 | 65.003 | 64.927 | 65.084 | 64.729 |
| Sodium Borate | 2.0 | 2.0 | 2.0 | 2.0 | 2.0 | 2.0 | 2.0 | 2.0 | 2.0 |
| Dowanol DPnB | 15.0 | 15.0 | 15.0 | 15.0 | 15.0 | 15.0 | 15.0 | 15.0 | 15.0 |
| Dowanol PPh | 5.0 | 5.0 | 5.0 | 5.0 | 5.0 | 5.0 | 5.0 | 5.0 | 5.0 |
| Neodol 1-5 | 3.0 | 3.0 | 3.0 | 3.0 | 3.0 | 3.0 | 3.0 | 3.0 | 3.0 |
| Neodol 1-9 | 4.0 | 4.0 | 4.0 | 4.0 | 4.0 | 4.0 | 4.0 | 4.0 | 4.0 |
| Pyridine | 0.402 | | | | | | | | |
| 2-Aminopyridine | | 0.478 | | | | | | | |
| Pyrimidine | | | 0.404 | | | | | | |
| 2-Aminopyrimidine | | | | 0.483 | | | | | |
| Anline | | | | | 0.473 | | | | |
| 3-Aminobenzoic Acid | | | | | | 0.697 | | | |
| 3,5-Diaminobenzoic Acid | | | | | | | 0.773 | | |
| 2-Aminobenzyl Amine | | | | | | | | 0.616 | |
| Nitrilotriacetic Acid | | | | | | | | | 0.971 |
| Isononanoic Acid | 4.0 | 4.0 | 4.0 | 4.0 | 4.0 | 4.0 | 4.0 | 4.0 | 4.0 |
| 50% NaOH | 1.0 | 1.0 | 1.0 | 1.0 | 1.0 | 1.0 | 1.0 | 1.0 | 2.25 |
| Zonyl NF | 0.3 | 0.3 | 0.3 | 0.3 | 0.3 | 0.3 | 0.3 | 0.3 | 0.3 |

The above stripper formulations were evaluated for stripper performance using the procedures of Example 1.

| 32 | | | | | | | | |
|---|---|---|---|---|---|---|---|---|
| oz/gal | Strokes to Remove Pencil Line | | | | | | | |
| Product | 7 | 6 | 5 | 4 | 3 | 2 | 1 | |
| Liq. | 36 | 54 | 71 | 97 | 114 | 132 | 161 | |
| Shovel | | | | | | | | |
| 9-152 | 31 | 49 | 55 | 81 | 89 | 98 | 109 | |
| 9-179 | 112 | — | — | — | — | — | — | Aniline, |
| | | | | | | | | 200 strokes |
| 9-180 | — | — | — | — | — | — | — | Pyridine, |
| | | | | | | | | 200 strokes |
| 9-181 | — | — | — | — | — | — | — | 2-Aminopyridine, |
| | | | | | | | | 200 strokes |

With products 9-179, 9-180, 9-181, there was no removal of pencil lines at 200 strokes as indicated.

| 32 oz/gal | Strokes to Remove Pencil Line | | | | | | | |
|---|---|---|---|---|---|---|---|---|
| Product | 7 | 6 | 5 | 4 | 3 | 2 | 1 | |
| Liq. Shovel | 29 | 39 | 55 | 70 | 72 | 79 | 112 | 125 strokes total |
| 9-152 | 16 | 35 | 42 | 52 | (46) | 61 | 79 | 100 strokes total |
| 9-182 | 67 | 99% | 50% | 50% | 99% | 5% | 10% | 3-Aminobenzoic |
| | | | | | | | | Acid, 200 strokes |
| 9-183 | 14 | 26 | 34 | 40 | 43 | 53 | 70 | 75 strokes total |
| 9-184 | 63 | 135 | 50% | 40% | 10% | — | 5% | 3,5-Diaminobenzoic |
| | | | | | | | | Acid, 200 strokes |
| 9-145 | 21 | 32 | 40 | 51 | 64 | 69 | 85 | 100 strokes total |
| 9-152 | 13 | 25 | 30 | 40 | 44 | 52 | 56 | 75 strokes total |
| 9-185 | 51 | 89 | 132 | 173 | 99% | 191 | 99% | 2-Aminopyrimidine, |
| | | | | | | | | 200 strokes total |
| 9-186 | 27 | 38 | 47 | 56 | 65 | 70 | 84 | 2-Aminobenzyl Amine, |
| | | | | | | | | 100 strokes total |
| 9-187 | 54 | 99 | 162 | (159) | 169 | 186 | 187 | Pyrimidine, |
| | | | | | | | | 200 strokes total |

In some instances, pencil lines 4, 3, 2 and 1 required fewer strokes than pencil line 5 due to the way the layers were formed in preparing the tiles.

### EXAMPLE 5

The following stripper formulations were prepared:

| Components | 9-150 | 10-10 | 10-10A |
|---|---|---|---|
| Soft Water | 67.225 | 66.5485 | 62.5485 |
| MEA | 0.31 | 1.0 | 5.0 |
| Dowanol DPnB | 20.0 | 20.0 | 20.0 |
| BzOH | 3.0 | 3.0 | 3.0 |
| Rose Floral | 0.15 | 0.15 | 0.15 |
| DDBSA | 2.0 | 2.0 | 2.0 |
| 45% KOH | 3.0 | 3.0 | 3.0 |
| Isononanoic Acid | 4.0 | 4.0 | 4.0 |
| Zonyl NF | 0.3 | 0.3 | 0.3 |
| Red S-438 | 0.0015 | 0.0015 | 0.0015 |

Revelation, a stripper formulation marketed under that trade designation by Buckeye International, Inc., St. Louis, Mo., was also prepared. In the above table, B_{z}OH is benzyl alcohol and MEA is monoethanol amine.

The above stripper formulations were evaluated for stripper performance using the procedures of Example 1.

| 32 oz/gal | Strokes to Remove Pencil Line | | | | | | | |
|---|---|---|---|---|---|---|---|---|
| Product | 7 | 6 | 5 | 4 | 3 | 2 | 1 | |
| Revelation | 14 | 23 | 31 | 32 | 32 | 32 | 33 | 15.0% MEA, 40 strokes |
| 9-150 | 182 | 5% | — | — | — | — | — | 0.31% MEA, 200 strokes |
| 10-10 | 91 | 107 | 117 | 104 | 108 | 106 | 120 | 1.0% MEA, 125 strokes |
| 10-10A | 48 | 62 | 64 | 63 | 70 | 70 | 73 | 5% MEA, 75 strokes |
| 9-157A | 17 | 24 | 34 | 37 | 43 | 46 | 49 | 0.9% Diethylene triamine, |
| | | | | | | | | 50 strokes |

The product “9-157A” is similar to products 9-150, 10-10 and 10-10A, but contains 0.9% by weight diethylene triamine instead of MEA.

### EXAMPLE 6

The following stripper formulations were prepared:

| Components | 10-15 | 10-11 | 11-14 |
|---|---|---|---|
| Soft Water | 64.7 | 62.61 | 59.2 |
| Na Borate | 2.0 | 2.0 | 2.0 |
| Dowanol DPnB | 15.0 | 15.0 | 15.0 |
| Dowanol PPh | 5.0 | 5.0 | 5.0 |
| Neodol 1-5 | 3.0 | 3.0 | 3.0 |
| Neodol 1-9 | 4.0 | 4.0 | 4.0 |
| Na Iminodisuccinate | — | — | — |
| Diethylene Triamine | 0.5 | 0.5 | 0.5 |
| Diethylenetriamine | 0.5 | 1.0 | 2.0 |
| Pentaacetic Acid | | | |
| Isononanoic Acid | 4.0 | 4.5 | 6.5 |
| 50% NaOH | 1.0 | 1.75 | 2.5 |
| Zonyl NF | 0.3 | 0.3 | 0.3 |

The above stripper formulations were evaluated for stripper performance using the procedures of Example 1.

| 32 oz/gal | Strokes to Remove Pencil Line | | | | | | |
|---|---|---|---|---|---|---|---|
| Product | 7 | 6 | 5 | 4 | 3 | 2 | 1 |
| Liquid Shovel | 34 | 44 | 64 | 77 | 104 | 121 | 136 |
| 10-15 | 12 | 27 | 33 | 40 | 45 | 57 | 65 |
| 10-11 | 11 | 20 | 28 | 37 | 40 | 49 | 56 |
| 10-14 | 14 | 27 | 37 | 42 | 52 | 64 | 75 |
| Revelation | 25 | 35 | 38 | 41 | 45 | 45 | 45 |

### EXAMPLE 7

Stripper formulations similar to those set forth in Example 2 were prepared and contained 0.00504 moles of the amine or chelant specified below in lieu of sodium iminodisuccinate (0.00504 moles) which is present in the stripper product sold under the trade designation Liquid Shovel by Buckeye International, Inc.

| Formulation | Amine or Chelant |
|---|---|
| 9-129A | Hampene 100S |
| 9-130 | 0.01 moles Hampene 100S |
| 9-131 | Liquid Gluconate 60 |
| 9-133 | Anthranillic acid |
| 9-134 | Monoethanol amine |
| 9-135 | Iminodiacetic acid |
| 9-145 | Ethylene diamine |
| 9-152 | Diethylene triamine |
| 9-152A | Triethylenetetramine |
| 9-153 | Tetraethylene Pentamine |
| 9-155 | Diethylenetriamine pentaacetic acid |
| 9-156 | Triethylenetetramine hexaacetic acid |

These formulations were evaluated for stripper performance using the procedures of Example 1 with the following results:

| 32 oz/gal | | | | | | | |
|---|---|---|---|---|---|---|---|
| Product | 7 | 6 | 5 | 4 | 3 | 2 | 1 |
| | Stripper Tests | | | | | | |
| | Strokes to Remove Pencil Line | | | | | | |
| 9-145 | 32 | 46 | 78 | 90 | 106 | 116 | 99% |
| 9-152 | 19 | 31 | 48 | 54 | 60 | 70 | 85 |
| 9-152A | 32 | 46 | 61 | 78 | 91 | 106 | 119 |
| 9-145 | 77 | 138 | 169 | — | — | — | — |
| 9-152 | 36 | 59 | 68 | 116 | 147 | 145 | 138 |
| 9-155 | 28 | 39 | 54 | 77 | 108 | 110 | 98 |
| 9-156 | 27 | 43 | 47 | 61 | 88 | 104 | 106 |
| | Stripper Tests - Tile G-179 | | | | | | |
| | Strokes to Remove Pencil Line | | | | | | |
| 9-129A | 26 | 44 | 55 | 67 | 90 | 94 | 107 |
| 9-130 | 22 | 36 | 40 | 56 | 74 | 85 | 91 |
| 9-131 | 134 | 99% after 200 strokes | | | | | |
| 9-133 | 178 | 75% after 200 strokes | | | | | |
| | Stripper Tests - Tile G-180 | | | | | | |
| | Strokes to Remove Pencil Line | | | | | | |
| 9-134 | 78 | 131 | 90% after 200 strokes | | | | |
| 9-135 | 25 | 34 | 44 | 56 | 67 | 81 | 103 |
| 9-145 | 31 | 50 | 63 | 82 | 117 | 112 | 85% after 125 |
| | | | | | | | strokes |

### EXAMPLE 8

Stripper formulations similar to those set forth in Example 2 were prepared and contained 0.00504 moles of the amines listed below in lieu of monoethanolamine (15% or 0.246 moles/100 grams) which is present in the stripper product sold under the trade designation Revelation by Buckeye International, Inc.

| Formulation | Amine |
|---|---|
| 9-150 | Monoethanolamine (0.00504 moles) |
| 9-151 | Ethylene diamine |
| 9-157 | Diethylene triamine |
| 9-157A | 0.009 moles Diethylene triamine |
| 9-161 | Sodium iminodisuccinate |
| 9-162 | Hampene 100S |

These formulations were evaluated for stripper performance using the procedures of Example 1 with the following results:

| 32 oz/gal | Strokes to Remove Pencil Line | | | | | | |
|---|---|---|---|---|---|---|---|
| Product | 7 | 6 | 5 | 4 | 3 | 2 | 1 |
| Revelation | 16 | 27 | 32 | 34 | 34 | 32 | 34 |
| 9-150 | 142 | — | — | — | — | — | — |
| 9-151 | 34 | 53 | 71 | 84 | 85 | 94 | 91 |
| 9-157 | 11 | 20 | 29 | 33 | 37 | 40 | 54 |
| 9-157A | 12 | 19 | 26 | 29 | 33 | 38 | 35 |
| Revelation | 18 | 28 | 30 | 30 | 30 | 31 | 27 |
| 9-161 | 16 | 32 | 36 | 49 | 55 | 67 | 79 |
| 9-162 | 26 | 36 | 50 | 64 | 77 | 93 | 117 |
| 9-157 | 16 | 29 | 36 | 39 | 54 | 58 | 67 |
| 9-157A | 15 | 27 | 29 | 33 | 39 | 45 | 46 |

In view of the above, it will be seen that the several objects of the invention are achieved and other advantageous results attained.

As various changes could be made in the above methods and compositions without departing from the scope of the invention, it is intended that all matter contained in the above description and shown in the accompanying drawings shall be interpreted as illustrative and not in a limiting sense.

What is claimed is:

1. A process for stripping metal cross linked floor finishes which comprises applying thereto a stripper formulation containing a compound selected from the group consisting of a chelant containing an amine functionality and a metal chelating ligand, an alkali metal salt of said chelant, an aliphatic or aromatic polyamine, said aromatic polyamine having the amine functionality in a substituent outside the aromatic ring, and mixtures of said chelant and polyamine.

2. A process as set forth in claim 1 wherein said chelant is selected from the group consisting of ethylenediamine tetraacetic acid, diethylenetriamine pentaacetic acid, triethylenetetramine hexaacetic acid, nitriloacetic acid, iminodisuccinic acid, and alkali metal salts thereof.

3. A process as set forth in claim 2 wherein said chelant is tetrasodium ethylenediamine tetraacetate.

4. A process as set forth in claim 2 wherein said chelant is sodium iminodisuccinate.

5. A process as set forth in claim 2 wherein said chelant is diethylenetriamine pentaacetic acid.

6. A process as set forth in claim 1 wherein said polyamine is selected from the group consisting of ethylene diamine, diethylene triamine, triethylene tetramine and tetraethylene pentamine.

7. A process as set forth in claim 1 wherein said polyamine is diethylene triamine.

8. A process as set forth in claim 1 wherein said stripper formulation contains a mixture of diethylene triamine and diethylenetriamine pentaacetic acid.

9. A process as set forth in claim 1 wherein said stripper formulation contains approximately 0.1% to approximately 10% by weight of said compound.

10. A process as set forth in claim 1 wherein said stripper formulation contains approximately 0.5% by weight of diethylene triamine.

11. In a process for stripping metal cross-linked floor finishes by applying thereto a stripper formulation, the improvement which comprises incorporating in said stripper formulation a compound selected from the group consisting of a chelant containing an amine functionality and a metal chelating ligand, an alkali metal salt of said chelant, an aliphatic or aromatic polyamine, said aromatic polyamine having the amine functionality in a substituent outside the aromatic ring, and mixtures of said chelant and polyamine.

12. A process as set forth in claim 11 wherein said chelant is selected from the group consisting of ethylenediamine tetraacetic acid, diethylenetriamine pentaacetic acid, triethylenetetramine hexaacetic acid, nitriloacetic acid, iminodisuccinic acid, and alkali metal salts thereof.

13. A process as set forth in claim 12 wherein said chelant is tetrasodium ethylenediamine tetraacetate.

14. A process as set forth in claim 12 wherein said chelant is sodium iminodisuccinate.

15. A process as set forth in claim 12 wherein said chelant is diethylenetriamine pentaacetic acid.

16. A process as set forth in claim 11 wherein said polyamine is selected from the group consisting of ethylene diamine, diethylene triamine, triethylene tetramine and tetraethylene pentamine.

17. A process as set forth in claim 11 wherein said polyamine is diethylene triamine.

18. A process as set forth in claim 11 wherein said stripper formulation contains a mixture of diethylene triamine and diethylenetriamine pentaacetic acid.

19. A process as set forth in claim 11 wherein said stripper formulation contains approximately 0.1% to approximately 10% by weight of said compound.

20. A process as set forth in claim 11 wherein said stripper formulation contains approximately 0.5% by weight of diethylene triamine.

21. A stripper formulation for use on metal cross linked floor finishes comprising a compound selected from the group consisting of a chelant containing an amine functionality and a metal chelating ligand, an alkali metal salt of said chelant, an aliphatic or aromatic polyamine, said aromatic polyamine having the amine functionality outside the aromatic ring, and mixtures of said chelant and polyamine.

22. A stripper formulation as set forth in claim 21 wherein said chelant is selected from the group consisting of ethylenediamine tetraacetic acid, diethylenetriamine pentaacetic acid, triethylenetetramine hexaacetic acid, nitriloacetic acid, iminodisuccinic acid, and alkali metal salts thereof.

23. A stripper formulation as set forth in claim 22 wherein said chelant is tetrasodium ethylenediamine tetraacetate.

24. A stripper formulation as set forth in claim 22 wherein said chelant is sodium iminodisuccinate.

25. A stripper formulation as set forth in claim 22 wherein said chelant is diethylenetriamine pentaacetic acid.

26. A stripper formulation as set forth in claim 21 wherein said polyamine is selected from the group consisting of ethylene diamine, diethylene triamine, triethylene tetramine and tetraethylene pentamine.

27. A stripper formulation as set forth in claim 21 wherein said polyamine is diethylene triamine.

28. A stripper formulation as set forth in claim 21 wherein said formulation contains a mixture of diethylene triamine and diethylenetriamine pentaacetic acid.

29. A stripper formulation as set forth in claim 21 wherein said formulation contains approximately 0.1% to approximately 10% by weight of said compound.

30. A stripper formulation as set forth in claim 21 wherein said formulation contains approximately 0.5% by weight of diethylene triamine.

31. In a stripper formulation for use on metal cross linked floor finishes and containing an organic solvent, a surfactant and an alkali, the improvement which comprises incorporating therein a compound selected from the group consisting of a chelant containing an amine functionality and a metal chelating ligand, an alkali metal salt of said chelant, an aliphatic or aromatic polyamine, said aromatic polyamine having the amine functionality in a substituent outside the aromatic ring, and mixtures of said chelants and polyamine.

32. A stripper formulation as set forth in claim 31 wherein said chelant is selected from the group consisting of ethylenediamine tetraacetic acid, diethylenetriamine pentaacetic acid, triethylenetetramine hexaacetic acid, nitriloacetic acid, iminodisuccinic acid, and alkali metal salts thereof.

33. A stripper formulation as set forth in claim 32 wherein said chelant is tetrasodium ethylenediamine tetraacetate.

34. A stripper formulation as set forth in claim 32 wherein said chelant is sodium iminodisuccinate.

35. A stripper formulation as set forth in claim 32 wherein said chelant is diethylenetriamine pentaacetic acid.

36. A stripper formulation as set forth in claim 31 wherein said polyamine is selected from the group consisting of ethylene diamine, diethylene triamine, triethylene tetramine and tetraethylene pentamine.

37. A stripper formulation as set forth in claim 31 wherein said polyamine is diethylene triamine.

38. A stripper formulation as set forth in claim 31 wherein said formulation contains a mixture of diethylene triamine and diethylenetriamine pentaacetic acid.

39. A stripper formulation as set forth in claim 31 wherein said formulation contains approximately 0.1% to approximately 10% by weight of said compound.

40. A stripper formulation as set forth in claim 31 wherein said formulation contains approximately 0.5% by weight of diethylene triamine.
